(19) United States
(12) Patent Application Publication
(10) Pub. No.: US 2026/0082327 A1
(43) Pub. Date: Mar. 19, 2026

(54) LOW POWER WAKE UP SEQUENCE AND NETWORK ENERGY SAVING PAGING OCCASION ADAPTATION

(71) Applicant: QUALCOMM Incorporated, San Diego, CA (US)

(72) Inventors: Diana MAAMARI, San Diego, CA (US); Ahmed Attia ABOTABL, San Diego, CA (US); Huilin XU, Temecula, CA (US)

(21) Appl. No.: 18/888,063

(22) Filed: Sep. 17, 2024

(51) Int. Cl. H04W 52/02; H04W 68/02; H04W 76/28

(52) U.S. Cl. CPC H04W 52/0235; H04W 68/02; H04W 76/28

(57) ABSTRACT

The apparatus may be a wireless device such as a user equipment (UE) configured to receive a first PO configuration associated with a first LO configuration, receive a PO adaptation indication of an update to the first configuration of POs associated with one or more PFs, and monitor, based on the received PO adaptation indication, LOs according to an updated LO configuration associated with the updated first configuration of POs. The apparatus, in some aspects, may be a network device configured to transmit a first PO configuration associated with a first LO configuration, transmit a PO adaptation indication of an update to the first configuration of POs associated with one or more PFs, and transmit, based on the received PO adaptation indication, at least one LP-WUS based on an updated LO configuration associated with the updated first configuration of POs.

### TECHNICAL FIELD

The present disclosure relates generally to communication systems, and more particularly, to wireless communication adaptation for network energy saving (NES).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a wireless device such as a user equipment (UE) configured to receive a first paging occasion (PO) configuration associated with a first low power wake up sequence (LP-WUS) occasion (LO) configuration, receive a PO adaptation indication of an update to the first configuration of POs associated with one or more paging frames (PFs), and monitor, based on the received PO adaptation indication, LOs according to an updated LO configuration associated with the updated first configuration of POs.

In an aspect of the disclosure, a method, a computer-readable medium, and an apparatus are provided. The apparatus may be a wireless device such as a network device or base station configured to transmit a first PO configuration associated with a first LO configuration, transmit a PO adaptation indication of an update to the first configuration of POs associated with one or more PFs, and transmit, based on the received PO adaptation indication, at least one LP-WUS based on an updated LO configuration associated with the updated first configuration of POs.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and UE in an access network.

FIG. 4 is a diagram of a first example modification of PFs/POs and associated LOs in accordance with some aspects of the disclosure.

FIG. 5A is a diagram illustrating an example of a modified LO configuration associated with the modified PF/PO configuration of FIG. 4 in accordance with some aspects of the disclosure.

FIG. 5B is a diagram illustrating an example of a modified PF/PO configuration associated with a bundling of PFs in frequency and an associated LO configuration in accordance with some aspects of the disclosure.

FIG. 5C is a diagram illustrating an example of a modified PF/PO configuration associated with an extended set of values for and an associated LO configuration in accordance with some aspects of the disclosure.

FIG. 6 is a call flow diagram illustrating a method of wireless communication in accordance with some aspects of the disclosure.

FIG. 7 is a flowchart of a method of wireless communication.

FIG. 8 is a flowchart of a method of wireless communication.

FIG. 9 is a flowchart of a method of wireless communication.

FIG. 10 is a diagram illustrating an example of a hardware implementation for an example apparatus and/or network entity.

FIG. 11 is a diagram illustrating an example of a hardware implementation for an example network entity.

FIG. 12 is a diagram illustrating an example of a hardware implementation for an example network entity.

### DETAILED DESCRIPTION

In some aspects of wireless communication, adaptations to common signals and or common channel transmissions may be made to provide network energy savings. For example, adaptations to one or more of a synchronization signal block (SSB) in a time-domain, a physical random access channel (PRACH) in the time-domain, the PRACH in a spatial domain, or paging occasions in the time domain and/or a frequency domain may be implemented to provide network energy savings.

Various aspects relate generally to adapting the LOs based on an adaptation of POs. Some aspects more specifically relate to providing and/or specifying how to identify a modified pattern of the LOs in association with a new configuration for adapted POs (e.g., NES POs, clustered POs, extended POs) so that UE does not wake-up unnecessarily. In some examples, a wireless device may be configured to receive a first PO configuration associated with a first LO configuration, receive a PO adaptation indication of an update to the first configuration of POs associated with one or more PFs, and monitor, based on the received PO adaptation indication, LOs according to an updated LO configuration associated with the updated first configuration of POs. In some examples, a network device may be configured to transmit a first PO configuration associated with a first LO configuration, transmit a PO adaptation indication of an update to the first configuration of POs associated with one or more PFs, and transmit, based on the received PO adaptation indication, at least one LP-WUS based on an updated LO configuration associated with the updated first configuration of POs.

Particular aspects of the subject matter described in this disclosure can be implemented to realize one or more of the following potential advantages. In some examples, by modifying the LO configuration based on a modified set of POs, the described techniques can be used to reduce the energy associated with monitoring for LOs and avoid monitoring for/of LOs that are not associated with POs.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (CNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

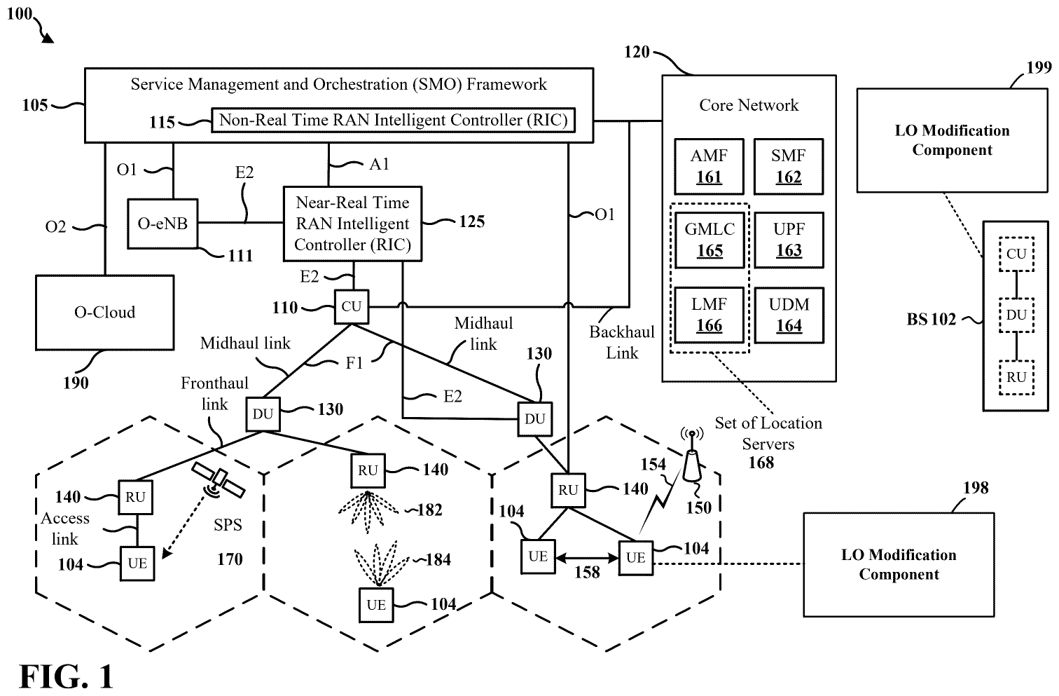

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-cNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHZ-7.125 GHZ) and FR2 (24.25 GHz-52.6 GHZ). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHZ), FR4 (71 GHz-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, cNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a LO modification component 198 that may be configured to receive a first PO configuration associated with a first LO configuration, receive a PO adaptation indication of an update to the first configuration of POs associated with one or more PFs, and monitor, based on the received PO adaptation indication, LOs according to an updated LO configuration associated with the updated first configuration of POs. In certain aspects, the base station 102 may have a LO modification component 199 that may be configured to transmit a first PO configuration associated with a first LO configuration, transmit a PO adaptation indication of an update to the first configuration of POs associated with one or more PFs, and transmit, based on the received PO adaptation indication, at least one LP-WUS based on an updated LO configuration associated with the updated first configuration of POs. Although the following description may be focused on 5G NR, the concepts described herein may be applicable to other similar areas, such as LTE, LTE-A, CDMA, GSM, and other wireless technologies.

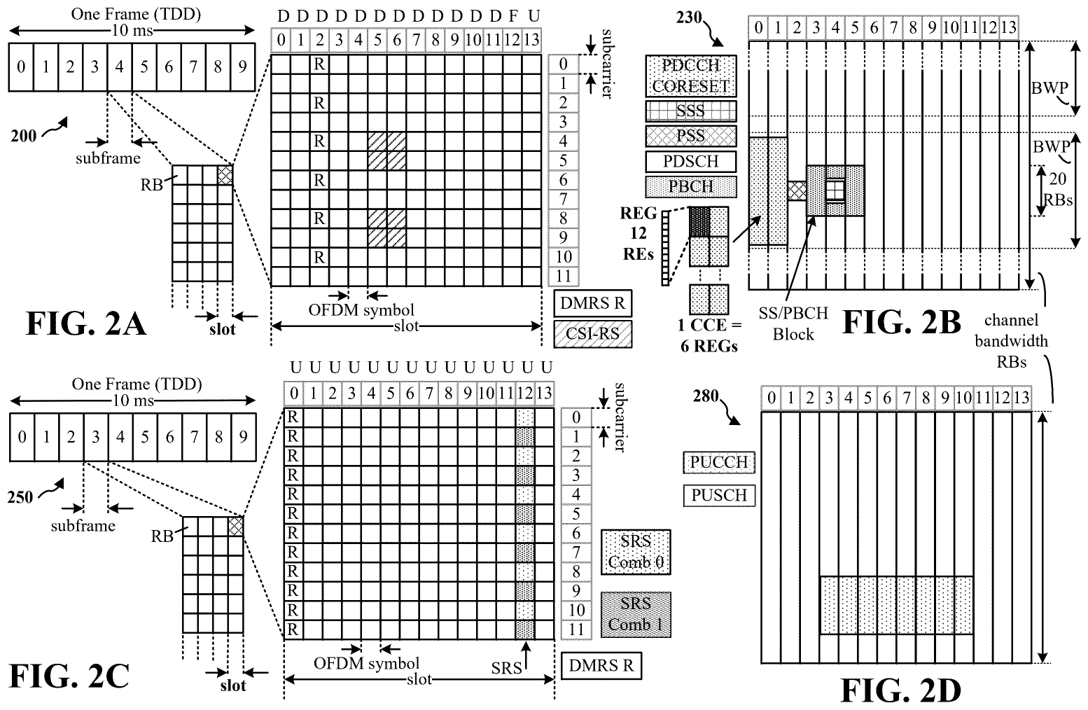

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 24 slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

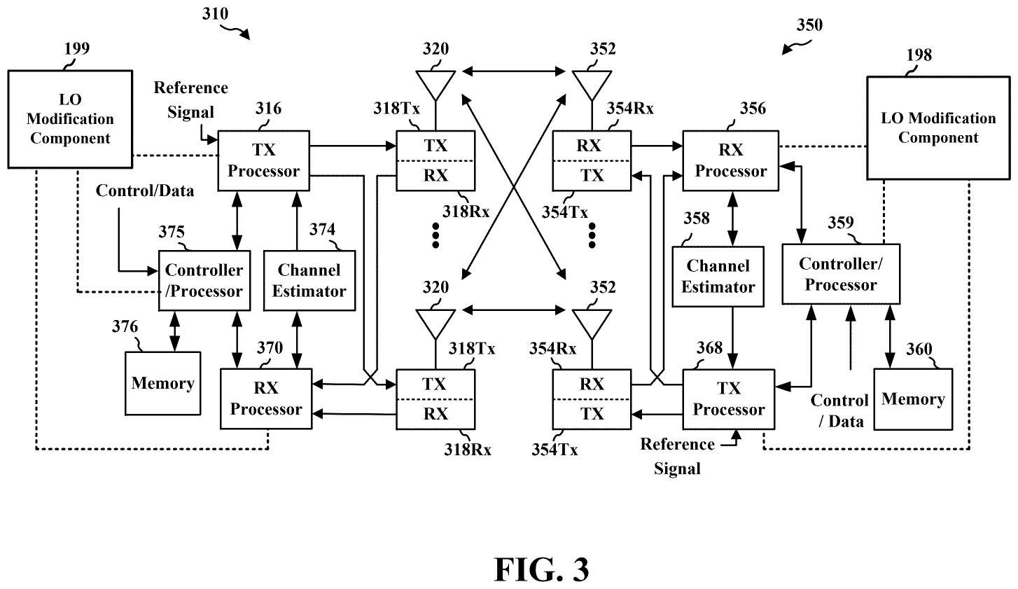

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antennas 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the LO modification component 198 of FIG. 1.

At least one of the TX processor 316, the RX processor 370, and the controller/processor 375 may be configured to perform aspects in connection with the LO modification component 199 of FIG. 1.

In association with achieving NES (e.g., a NES mode of operation), different aspects of wireless communication may be modified and or optimized. For example, in some aspects, on-demand SSB for secondary cell (Scell) operation for UEs in an RRC Connected mode using carrier aggregation (CA), such as intra-band CA and/or inter-band CA may be used to achieve NES. For the on-demand SSB, the triggering method, in some aspects, may be selected from: UL wake-up signal, cell on/off indication via backhaul, and/or Scell activation/deactivation signaling. In some aspects, on-demand SIBI for UEs in RRC Idle/Inactive may also be used, where a triggering method may be one of: UL wake-up signal (using existing signal), wake-up signal configuration (e.g., with no SSB modification), or information exchange between gNBs at least for config of UL wake-up signal.

In some aspects of wireless communication, adaptations to common signals and or common channel transmissions may be made to provide network energy savings. For example, adaptations to one or more of a SSB in a time-domain, a PRACH in the time-domain, the PRACH in a spatial domain, or POs (or PFs) in the time domain and/or a frequency domain may be implemented to provide network energy savings.

Various aspects relate generally to adapting the LOs based on an adaptation of POs. Some aspects more specifically relate to providing and/or specifying how to identify a modified pattern of the LOs in association with a new configuration for adapted POs (e.g., NES POs, clustered POs, extended POs) so that UE does not wake-up unnecessarily. In some examples, a wireless device may be configured to receive a first PO configuration associated with a first LO configuration, receive a PO adaptation indication of an update to the first configuration of POs associated with one or more PFs, and monitor, based on the received PO adaptation indication, LOs according to an updated LO configuration associated with the updated first configuration of POs. In some examples, a network device may be configured to transmit a first PO configuration associated with a first LO configuration, transmit a PO adaptation indication of an update to the first configuration of POs associated with one or more PFs, and transmit, based on the received PO adaptation indication, at least one LP-WUS based on an updated LO configuration associated with the updated first configuration of POs.

In some aspects, the PFs/POs may be configured based on (or specified using) a period (T, measured in radio frames) of a discontinuous reception (DRX) cycle and an additional number (nB) specifying a number of POs in each DRX cycle that, in some aspects, may take any of the values {T/32, T/16, T/8, T/4, T/2, T, 4T}. For a particular UE associated with a UE identifier (UEID), an associated PF may be identified based on a SFN and a value (N) based on T and nB, e.g., SFN mod T=(T/N)*(UEID mod N), where N=min(T, nB). Subsequently, the PO for the particular UE may be determined and/or identified based on iₛ=(UEID/N) mod Nₛ, where Nₛ=max(1, nB/T) is the number of POs in a PF, and iₛ indicates a sub-frame number associated with the PO in the PF, the value of which is pre-defined for each value of Nₛ. In some aspects, a UE may include a low power wake up radio (LP-WUR) that may be used to monitor for a LP-WUS during a LO, where the LP-WUR may use less power than a different radio component of the UE used to monitor for and/or receive a paging signal in a PO.

In some aspects, a configuration of LOs may be associated with a configuration of POs. The LO configuration, in some aspects, may include a set of LOs corresponding to POs in a PO configuration. The LOs corresponding to the POs may have a one-to-one relationship such that each PO is associated with a LO (e.g., an LO that may be identified for monitoring by a UE configured to monitor the associated PO). In some aspects, one LO may be associated with one or multiple POs. One or multiple LOs may, in some aspects, be associated with one PO.

In some aspects, the LO configuration may be configured and/or provided independently from the PO configuration. For example, the LO configuration may be determined without considering the PO configuration or without any association with PO. In some aspects, UEs may be divided into multiple groups that are independent from the paging groups, and each UE monitors one LO (e.g., one LO in each DRX cycle). For example, UEs belonging to a same paging group, in some aspects, may belong to different LO groups, and vice versa. For the case where the UE monitors a PO (e.g., a legacy PO or adapted PO) after receiving a LP-WUS indicating wake-up, the UE may monitor the first PO after a minimum wake-up delay after receiving the LP-WUS.

A PO (or PF/PO) adaptation, in some aspects, may be employed to achieve NES. In some aspects implementing and/or using a PO adaptation, each UE may monitor for one paging early indicator (PEI) (or LO) and/or PO during each paging DRX cycle. This behavior may be the same as when not implementing and/or using a PO adaptation, but the location of any of the PEI, the LO, and/or the PO may be different between a first PO configuration and a PO configuration based on a PO adaptation. For example, a PO adaptation in a time domain may (a) bundle paging frames and/or (b) extend the values of N (e.g., by allowing for additional values of nB such as T/128 and T/64) to have an increased interval between PFs and compensating for the decrease in the number of PFs by increasing the number of POs associated with each PF (e.g., the number of POs per PF, or Nₛ). For paging adaptation, UEs not configured to implement the PO adaptation (e.g., legacy UEs in a RRC Idle/Inactive mode of operation) may be prevented from access based on barring or the network may provide separate paging resources for legacy UEs and UEs configured to implement PO adaptation (e.g., NES-capable UEs).

In some aspects, PO adaptation may be used to confine network transmissions to a limited time period. Other adaptation techniques may include dynamic adaptation of the paging configuration, such as adapting the number of PFs and/or the number of POs. When adapting the PFs/POs, if no associated adaptation of the LOs is performed, the low power wake up radio (LP-WUR) may wake up unnecessarily for monitoring LOs that are associated with non-existent POs thus wasting energy and/or increasing the power consumption at the UE. In some aspects, the POs (e.g., after PO adaptation) may be confined or restricted to a shorter time period (e.g., bundled due to bundling of PFs) such that the LOs may not need to be distributed across the POs since the effective periodicity of the POs has changed (been reduced within the bundled PFs and/or the shorter time period). For example, for adapted POs bundled at the beginning of a paging DRX cycle, a LO in the middle of the paging DRX cycle may be too far removed from a next PO, while a single LO at the beginning of the paging DRX cycle may be close enough in time to one or more POs.

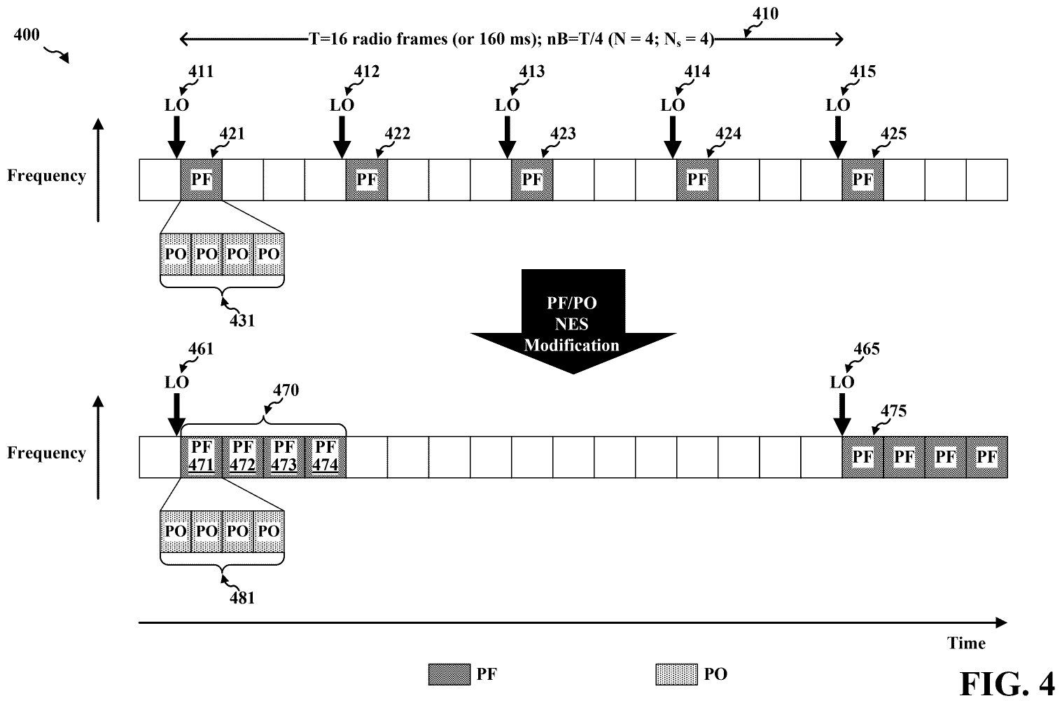

FIG. 4 is a diagram 400 of a first example modification of PFs/POs and associated LOs in accordance with some aspects of the disclosure. For a first PF/PO configuration associated with T=16 radio frames (e.g., 160 ms) and nB=T/4 (e.g., N=4, and Nₛ=4), there may be multiple PFs (e.g., PF 421, PF 422, PF 423, and PF 424) associated with a first DRX cycle 410 and additional PFs (including PF 425) associated with a subsequent DRX cycle. Each PF may be associated with a set of one or more POs such as the set of POs 431 including 4 POs). In some aspects, in addition to the configuration of the PFs and POs, a UE may be configured with (or determine based on the PF/PO configuration) an LO configuration. For example, the LO configuration may include an LO associated with each PF or set of POs (e.g., LO 411 associated with PF 421 and the set of POs 431, LO 412 associated with PF 422, LO 413 associated with PF 423, and LO 414 associated with PF 424) associated with a first DRX cycle 410 and additional LOs (including LO 415 associated with PF 425) associated with a subsequent DRX cycle. In some aspects, the LO configuration may include other relationships between LOs and PFs/POs as described above.

Diagram 400 further illustrates that, in some aspects, a modified PF/PO configuration (e.g., a PF/PO adaptation configuration) may be provided to a UE such that longer time periods may separate groups of PFs/POs allowing for longer periods of low power operation between PFs/POs. For example, in a first modified PF/PO configuration (e.g., based on a first PF/PO adaptation configuration) a set of PFs may be bundled (or aggregated) at a location (in time) within a DRX cycle (e.g., the first DRX cycle 410). The bundled set of PFs, in some aspects, may include a same number of PFs (e.g., a set of four PFs 470 including PF 471, PF 472, PF 473, and PF 474) and the PFs may have a same set of POs as in the first PF/PO configuration (e.g., including the set of POs 481). In some aspects, in addition to modifying the configuration of the PFs and POs, a UE may be configured with (or determine based on the PF/PO configuration) a modified LO configuration (e.g., a LO adaptation configuration). For example, the LO adaptation configuration may include an LO associated with each set of bundled and/or aggregated PF (e.g., LO 461 associated with the set of four PFs 470 or LO 465 associated with the set of bundled and/or aggregated PFs including PF 475).

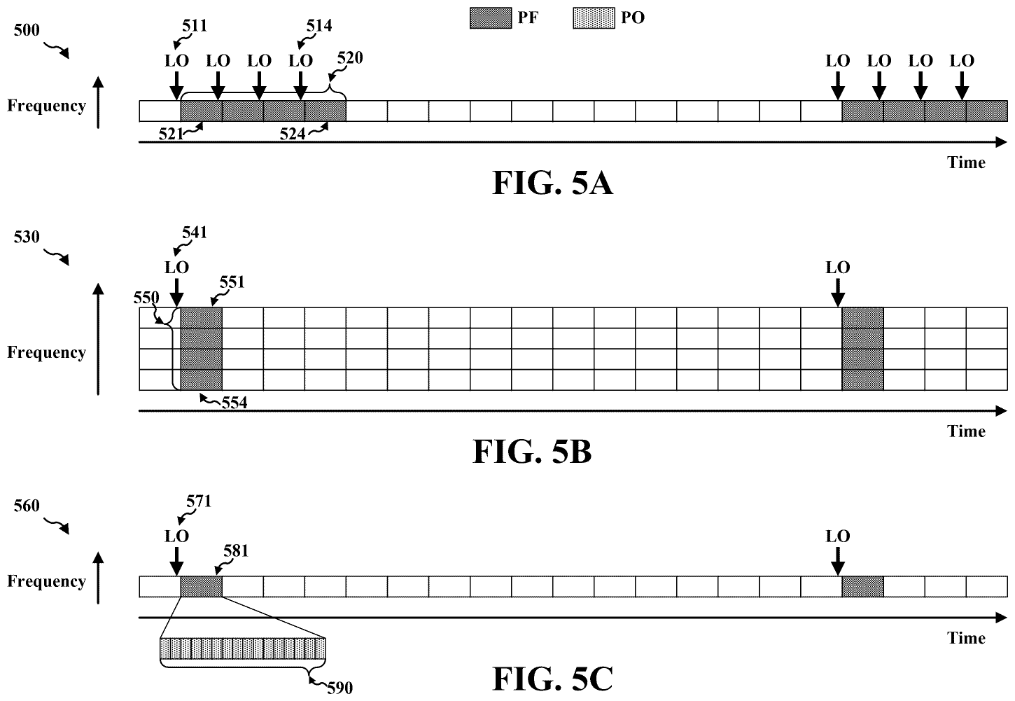

FIG. 5A is a diagram 500 illustrating an example of a modified LO configuration associated with the modified PF/PO configuration of FIG. 4 in accordance with some aspects of the disclosure. Diagram 500 illustrates a set of PFs 520 (e.g., aggregated and/or bundled PFs) including a first PF 521 and a fourth PF 524. In some aspects, the LO configuration may associate a LO with each PF (e.g., a first LO 511 may be associated with the first PF 521 and a fourth LO 514 may be associated with a fourth PF 524). For example, if there is at least a threshold time between POs associated with different PFs in a same set of bundled PFs, multiple LOs may be configured and monitored by one or more UEs (where each UE may monitor one or more LOS associated with the modified LO configuration). As described above, the modified LO configuration may be associated with the modified PF/PO configuration such that the location of the LOs of the modified LO configuration may be identified based on the locations of the PFs/POs of the modified PF/PO configuration. In some aspects, the modified LO configuration may be based on a separate LO configuration.

FIG. 5B is a diagram 530 illustrating an example of a modified PF/PO configuration associated with a bundling of PFs in frequency and an associated LO configuration in accordance with some aspects of the disclosure. Diagram 530 illustrates a set of PFs 550 (e.g., bundled and/or aggregated PFs) including a first PF 551 and a fourth PF 554. In some aspects, the LO configuration may associate a LO with the set of PFs 550 (e.g., a LO 541 may be associated with the set of PFs 550 including the first PF 551 and the fourth PF 554). As described above, the modified LO configuration may be associated with the modified PF/PO configuration such that the location of the LOs (e.g., in time and/or frequency) of the modified LO configuration may be identified based on the locations of the PFs/POs of the modified PF/PO configuration. In some aspects, the modified LO configuration may be based on a separate LO configuration.

FIG. 5C is a diagram 560 illustrating an example of a modified PF/PO configuration associated with an extended set of values for nB and an associated LO configuration in accordance with some aspects of the disclosure. In some aspects, the extended values for nB may include T/128 and T/64 leading to a reduced number of PFs in a DRX cycle. For example, diagram 560 illustrates a PF 581 (e.g., a single PF) that may be based on a nB of T/128 (as opposed to a nB of T/32 leading to a N of 4). In some aspects, the LO configuration may associate a single LO with the PF 581 (e.g., a LO 571 may be associated with the PF 581). The number of POs in each PF may be increased (e.g., to fully or partially offset the reduction in the number of PFs or to increase the total number of POs), e.g., the set of POs 590 associated with the PF 581 includes a larger number of POs than the set of POs 431 associated with PF 421 of FIG. 4. As described above, the modified LO configuration may be associated with the modified PF/PO configuration such that the location of the LOs of the modified LO configuration may be identified based on the locations of the PFs/POs of the modified PF/PO configuration. In some aspects, the modified LO configuration may be based on a separate LO configuration. FIGS. 4, 5A, 5B, and 5C illustrate different examples associated with (or possibilities for) modifying a PF/PO configuration (e.g., based on a PF/PO adaptation configuration) and examples associated with (or possibilities for) modifying a LO configuration based on, or in association with, a modified PF/PO configuration or based on a LO adaptation configuration. The different examples of PF/PO modification may be combined in some aspects (e.g., bundling PFs into a smaller number of PFs each having additional POs, or bundling four PFs into two frames across two frequencies, etc.). Similarly, the different modifications to the LO configurations illustrated in FIGS. 4, 5A, 5B, and 5C may be used for, or combined with, different PF/PO modifications than the PF/PO modifications illustrated in FIGS. 4, 5A, 5B, and 5C (e.g., the multiple LOs illustrated in FIG. 5A may be configured in association with subsets of the set of POs 590 in FIG. 5C, or with different frequencies associated with the set of PFs 550 at the same time as the LO 541 of FIG. 5B, etc.).

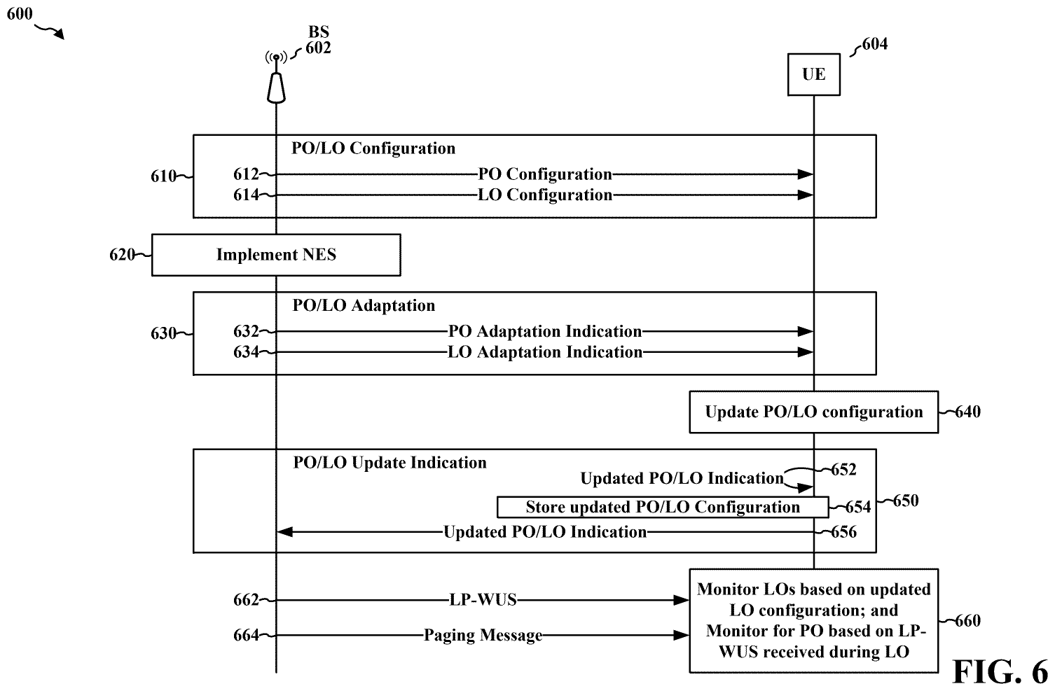

FIG. 6 is a call flow diagram 600 illustrating a method of wireless communication in accordance with some aspects of the disclosure. The method is illustrated in relation to a base station 602 (e.g., as an example of a network device or network node that may include one or more components of a disaggregated base station) in communication with a UE 604 (e.g., as an example of a wireless device). The functions ascribed to the base station 602, in some aspects, may be performed by one or more components of a network entity, a network node, or a network device (a single network entity/node/device or a disaggregated network entity/node/device as described above in relation to FIG. 1). Similarly, the functions ascribed to the UE 604, in some aspects, may be performed by one or more components of a wireless device supporting communication with a network entity/node/device. Accordingly, references to “transmitting” in the description below may be understood to refer to a first component of the base station 602 (or the UE 604) outputting (or providing) an indication of the content of the transmission to be transmitted by a different component of the base station 602 (or the UE 604). Similarly, references to “receiving” in the description below may be understood to refer to a first component of the base station 602 (or the UE 604) receiving a transmitted signal and outputting (or providing) the received signal (or information based on the received signal) to a different component of the base station 602 (or the UE 604).

In some aspects, to configure PFs, POs, and LOs associated with a UE at 610, the base station 602 may transmit, and a UE 604 may receive, a PO configuration 612. In some aspects, the UE 604 may determine a LO configuration (e.g., a location in time and frequency or a time-and-frequency resource grid) based on the PO configuration 612. For example, the UE 604 may determine the LO configuration based on a known or configured mapping from POs to LOs (e.g., a PO to LO mapping received via RRC signaling, a MAC-CE, or other static or semi-static configuration). As discussed above, the mapping may indicate one of a one-to-one relationship, a one-to-multiple relationship, and/or a multiple-to-one relationship between LOs and POs. In aspects in which the LO may not be wholly determined based on the PO configuration 612, the base station 602 may transmit, and the UE 604 may receive, a LO configuration 614. The LO configuration 614, in some aspects, may provide configuration information that allows the determination of the location in time and/or frequency of LOs based on the PO configuration 612. Alternatively, or additionally, and as discussed above, the LO configuration 614 may be independent from the PO configuration 612, such that the UE may, upon receiving a LP-WUS indicating wake-up during a LO, monitor the first PO (e.g., a first PO identified for the UE 604 based on a UEID) after a minimum wake-up delay after receiving the LP-WUS, where the number of POs monitored based on receiving a LP-WUS indicating wake-up may depend, or be based, on a relative location and/or density (or periodicity) of LOs and POs.

The UE 604 may configure the POs based on the PO configuration 612 and may configure the LOs based on the PO configuration 612 and/or the LO configuration 614. The base station 602 may, at 620 determine to implement NES or a NES mode of operation. The NES implemented at 620, in some aspects, may include a PO adaptation as depicted in FIGS. 4, 5A, 5B, and 5C. Based on the PO adaptation at the base station 602, the base station 602 initiate PO/LO adaptation at 630. For example, to initiate the PO/LO adaptation at 630, in some aspects, the base station 602 may transmit, and the UE 604 may receive, PO adaptation indication 632. The PO adaptation indication 632, in some aspects, may be received via a MAC-CE or DCI. In some aspects, the PO adaptation indication 632 may indicate one or more of increasing and/or decreasing a paging cycle (e.g., a DRX cycle), increasing and/or decreasing POs (or PFs) within a paging cycle, a PF bundling in one or more of time and/or frequency, and/or POs that may not be associated with a paging message (e.g., may be skipped). In some aspects, the UE 604 may determine a LO adaptation (e.g., an adaptation to the LO configuration previously configured based on the PO configuration 612 and/or the LO configuration) based on the PO adaptation indication 632. For example, the UE 604 may determine the LO adaptation based on an updated PO configuration (based on the PO adaptation indication 632) and the known or configured mapping from POs to LOs (e.g., a PO-to-LO mapping received via RRC signaling, a MAC-CE, or other static or semi-static configuration). As discussed above, the mapping may indicate one of a one-to-one relationship, a one-to-multiple relationship, and/or a multiple-to-one relationship between LOs and POs. In some aspects, the updated parameters included in the PO adaptation indication 632 may be used to determine the LO adaptation. In some aspects, the LO adaptation may not be (wholly) determined based on the PO adaptation indication 632 and the base station 602 may transmit, and the UE 604 may receive, a LO adaptation indication 634. The LO adaptation indication 634, in some aspects, may be received via a MAC-CE or DCI, and in some aspects, may be received in a same MAC-CE or DCI carrying the PO adaptation indication 632. In some aspects, the LO adaptation indication 634 may indicate one or more of increasing and/or decreasing a paging cycle (e.g., a DRX cycle), increasing and/or decreasing LOs within a paging cycle, a LO associated with PF bundling in one or more of time and/or frequency, and/or LOs that may be skipped (LOs for which the base station 602 may not transmit a LP-WUS) based on being associated with POs that may not be associated with a paging message (e.g., for which the base station 602 may not transmit a paging message). As discussed above, the LO adaptation indication 634 may be independent from the PO adaptation indication 632, such that the UE may update the LO configuration based on the LO adaptation indication 634 differently than the UE updated the PO configuration based on the PO adaptation indication 632.

At 640, the UE 604 may update the PO configuration and/or the LO configuration. In some aspects, the updated PO configuration may be associated with a PF bundling (e.g., in time and/or frequency) as illustrated in (or described in relation to) FIGS. 4, 5A, and/or 5B. For an updated PF configuration associated with a PF bundling, the updated LO configuration may include a single LO associated with the bundled (or aggregated) PFs/PO. For example, referring to FIG. 4, a single LO (e.g., LO 461) may be indicated for, or associated with, the set of bundled PFs including PFs 471 to 474. In some aspects, the updated LO configuration may include multiple LOs each associated with a subset of PFs in a set of bundled PFs. For example, referring to FIG. 5A, a first LO (e.g., the first LO 511) may be indicated for, or associated with, a subset of the PFs in the set of bundled PFs (e.g., the set of PFs 520), where the subset of the PFs may include PF 521 (one LO per PF) or may include the first PF 521 and the second PF in the set of PFs 520 (two PFs per LO) if, for example, the second LO (the LO following the first LO 511) is not indicated as an LO by the updated LO configuration. The determination to associate multiple LOs with a set of bundled PFs (or POs), e.g., to associate each LO with a different subset of PFs in a set of bundled PFs, in some aspects, may be based on a time between PFs and/or POs (or adjacent subsets of PFs in the set of bundled PFs) being greater than a threshold time (e.g., being separated by, at least, a threshold time). In some aspects, a UE that is not configured to update the PO configuration and/or the LO configuration (e.g., a legacy UE) may monitor LOs associated with legacy PF(s) and legacy PO(s) which occur within the set of bundled PFs, while a UE configured to update the PO configuration and/or the LO configuration (e.g., a NES-capable UE) based on the PO adaptation indication 632 and/or the LO adaptation indication 634 may monitor the LO(s) associated with the updated LO configuration.

In some aspects, subgrouping can be different for the same UE. Some POs, in some aspects, may be monitored by UEs not configured to update the PO configuration and/or the LO configuration (e.g., legacy UEs), while some POs may be monitored by the legacy UEs and the NES-capable UEs. In some aspects a UE Subgroup ID assigned by the core network may be different for the same NES-capable UEs.

Based on the update to the PO configuration and the LO configuration, the UE 604 may, at 650, output an indication 652 of the updated PO configuration and/or the updated LO configuration (or an indication that the UE has completed the update of the PO configuration and/or the LO configuration). Outputting the updated PO configuration and/or the LO configuration, in some aspects, may include storing the updated PO configuration and/or the updated LO configuration locally at 654 to use as a basis for monitoring POs and/or LOs at 660. In some aspects, the UE 604 may transmit, and the base station 602 may receive, an updated PO/LO indication 656 that may include an indication of the updated PO configuration and/or the updated LO configuration (or an indication that the UE has completed the update of the PO configuration and/or the LO configuration).

At 660, the UE may monitor LOs based on the updated LO configuration and, if a LP-WUS is received during a LO, may monitor a PO. In some aspects, the updated PO configuration and the updated LO configuration may be associated with monitoring at least one LO and/or PO per DRX cycle. The LP-WUS, in some aspects, may indicate the adaptation of the paging and/or PRACH configuration. In some aspects, when the base station 602 has data to transmit to the UE 604, the base station 602 may transmit, and the UE 604 may receive, LP-WUS 662 and the paging message 664. The LP-WUS 662, in some aspects, may be received during a LO monitored based on the updated LO configuration and the paging message may be received during a PO based on the updated PO configuration.

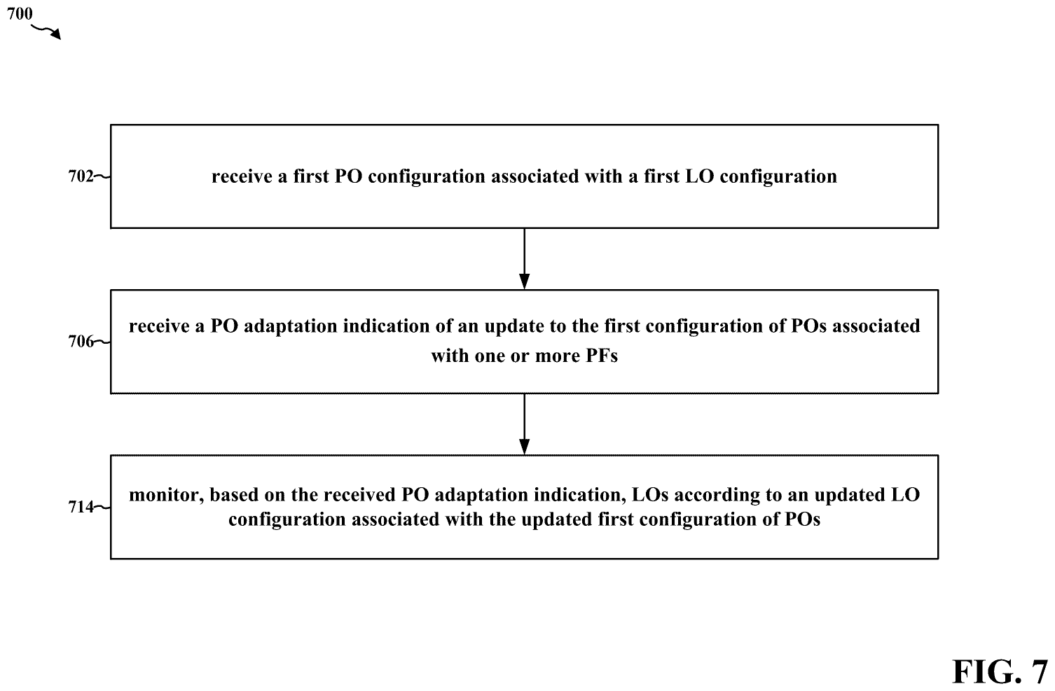

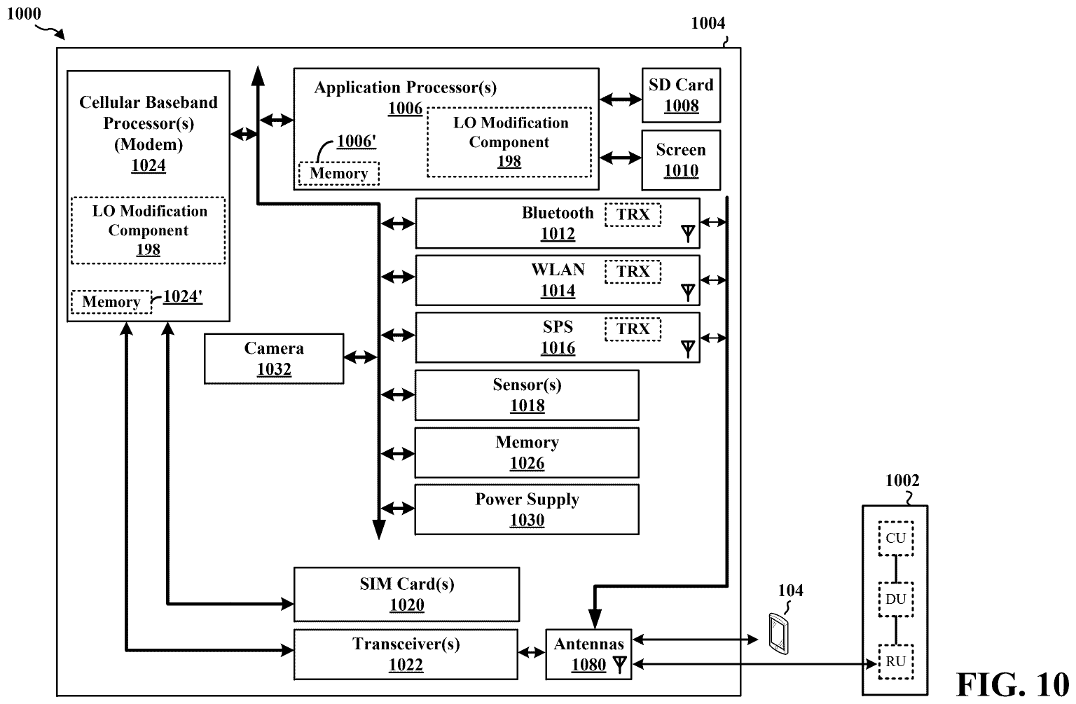

FIG. 7 is a flowchart 700 of a method of wireless communication. The method may be performed by a UE (e.g., the UE 104, 604; the apparatus 1004). At 702, the UE may receive a first PO configuration associated with a first LO configuration. For example, 702 may be performed by application processor(s) 1006, cellular baseband processor(s) 1024, transceiver(s) 1022, antenna(s) 1080, and/or LO modification component 198 of FIG. 10. For example, referring to FIG. 6, the UE 604 may receive the PO configuration 612.

In some aspects, the UE may receive the first LO configuration. In some aspects, receiving the first LO configuration may include receiving a mapping from the PO configuration to the first LO configuration. For example, referring to FIG. 6, the UE 604 may receive the LO configuration 614.

At 706, the UE may receive a PO adaptation indication of an update to the first configuration of POs associated with one or more PFs. For example, 706 may be performed by application processor(s) 1006, cellular baseband processor(s) 1024, transceiver(s) 1022, antenna(s) 1080, and/or LO modification component 198 of FIG. 10. In some aspects, the updated first configuration of POs may be associated with PF bundling. The PF bundling may be associated with at least one of a time domain or a frequency domain. In some aspects, the PO adaptation indication may be associated with a NES mode of operation. The indication may be a DCI or other signal indicating one or more of a modification to a paging cycle (e.g., a DRX cycle), a modification of the POs (or PFs) within a paging cycle, a PF bundling in one or more of time and/or frequency, or POs that may not be associated with a paging message (e.g., may be skipped). In some aspects, the PO adaptation indication may be associated with an increased periodicity associated with the one or more PFs (or POs). The increased periodicity associated with the one or more PFs, in some aspects, may be a first increased periodicity, and the PO adaptation indication may be associated with an increased number of POs associated with each PF of the one or more PFs that may be based on the first increased periodicity. In some aspects, the increased number of POs associated with each PF may result in one of an increased number of POs, a same number of POs, or a reduced number of POs associated with a DRX cycle. For example, referring to FIG. 6, the UE 604 may receive the PO adaptation indication 632.

In some aspects, the UE may receive a LO adaptation indication associated with the PO adaptation indication. In some aspects, receiving the PO adaptation indication at 706 and receiving the LO adaptation indication may include receiving the PO adaptation indication and the LO adaptation indication in a same indication. The indication may be a DCI or other signal indicating one or more of a modification to a paging cycle (e.g., a DRX cycle), a modification of the POs (or PFs) within a paging cycle, a PF bundling in one or more of time and/or frequency, or POs that may not be associated with a paging message (e.g., may be skipped). In some aspects, the PO adaptation indication may be associated with an increased periodicity associated with the one or more PFs (or POs). The updated LO configuration, in some aspects, may include adapting a periodicity of LOs associated with the first LO configuration based on the increased periodicity associated with the one or more PFs (or POs). The increased periodicity associated with the one or more PFs, in some aspects, may be a first increased periodicity, and the PO adaptation indication may be associated with an increased number of POs associated with each PF of the one or more PFs that may be based on the first increased periodicity. In some aspects, the increased number of POs associated with each PF may result in one of an increased number of POs, a same number of POs, or a reduced number of POs associated with a DRX cycle. For example, referring to FIG. 6, the UE 604 may receive the LO adaptation indication 634.

In some aspects, the UE may update, based on the PO adaptation indication, the first PO configuration to generate the updated PO configuration based on the PO adaptation indication. For example, referring to FIG. 6, the UE 604 may update the PO configuration at 640. In some aspects, the UE may update, based on the LO adaptation indication, the first LO configuration based on the LO adaptation indication to generate the updated LO configuration associated with the updated first configuration of POs. The updated LO configuration, in some aspects, may include one LO associated with a set of bundled PFs. In some aspects, the updated LO configuration may include multiple LOs associated with a set of bundled PFs, where each LO of the multiple LOs may be associated with a corresponding subset of the set of bundled PFs in a plurality of subsets of bundled PFs. The adjacent subsets of the plurality of subsets of bundled PFs, in some aspects, may be separated by a threshold time. In some aspects, the updated LO configuration may include at least one LO during each paging DRX cycle. For example, referring to FIG. 6, the UE 604 may update the LO configuration at 640.

At 714, the UE may monitor, based on the received PO adaptation indication, LOs according to an updated LO configuration associated with the updated first configuration of POs. For example, 714 may be performed by application processor(s) 1006, cellular baseband processor(s) 1024, transceiver(s) 1022, antenna(s) 1080, and/or LO modification component 198 of FIG. 10. In some aspects, monitoring the LOs may be associated with a low-power radio (e.g., a low-power wakeup radio or LP-WUR) of the UE. For example, referring to FIG. 6, the UE 604 may monitor LOs based on the updated LO configuration at 660.

In some aspects, the UE may output an indication of the configuration of the updated LO configuration. Outputting the indication of the configuration of the updated LO configuration, in some aspects, may include one of transmitting the indication of the configuration of the updated LO configuration, or storing the indication of the configuration of the updated LO configuration. For example, referring to FIG. 6, the UE 604 may, at 650, output an indication of the updated PO configuration and/or the updated LO configuration (or an indication that the UE has completed the update of the PO configuration and/or the LO configuration). Outputting the updated PO configuration and/or the LO configuration, in some aspects, may include storing the updated PO configuration and/or the updated LO configuration locally at 654 to use as a basis for monitoring POs and/or LOs at 660. In some aspects, the UE 604 may transmit, and the base station 602 may receive, an updated PO/LO indication 656 that may include an indication of the updated PO configuration and/or the updated LO configuration (or an indication that the UE has completed the update of the PO configuration and/or the LO configuration).

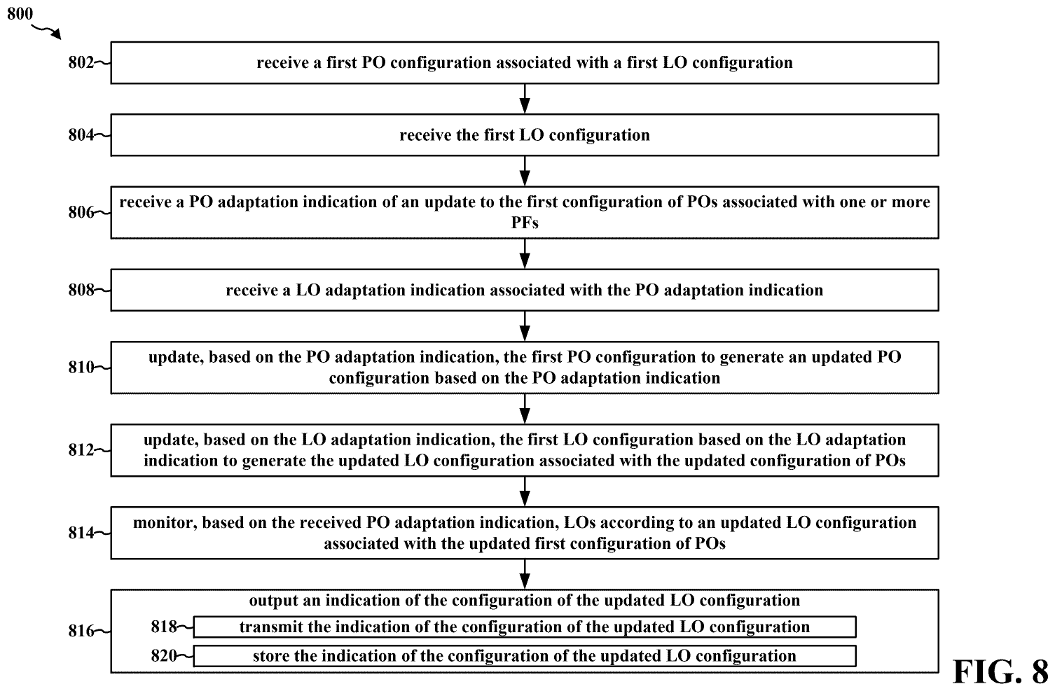

FIG. 8 is a flowchart 800 of a method of wireless communication. The method may be performed by a UE (e.g., the UE 104, 604; the apparatus 1004). At 802, the UE may receive a first PO configuration associated with a first LO configuration. For example, 802 may be performed by application processor(s) 1006, cellular baseband processor(s) 1024, transceiver(s) 1022, antenna(s) 1080, and/or LO modification component 198 of FIG. 10. For example, referring to FIG. 6, the UE 604 may receive the PO configuration 612.

At 804, the UE, in some aspects, may receive the first LO configuration. For example, 804 may be performed by application processor(s) 1006, cellular baseband processor(s) 1024, transceiver(s) 1022, antenna(s) 1080, and/or LO modification component 198 of FIG. 10. In some aspects, receiving the first LO configuration may include receiving a mapping from the PO configuration to the first LO configuration. For example, referring to FIG. 6, the UE 604 may receive the LO configuration 614.

At 806, the UE may receive a PO adaptation indication of an update to the first configuration of POs associated with one or more PFs. For example, 806 may be performed by application processor(s) 1006, cellular baseband processor(s) 1024, transceiver(s) 1022, antenna(s) 1080, and/or LO modification component 198 of FIG. 10. In some aspects, the updated first configuration of POs may be associated with PF bundling. The PF bundling may be associated with at least one of a time domain or a frequency domain. In some aspects, the PO adaptation indication may be associated with a NES mode of operation. The indication may be a DCI or other signal indicating one or more of a modification to a paging cycle (e.g., a DRX cycle), a modification of the POs (or PFs) within a paging cycle, a PF bundling in one or more of time and/or frequency, or POs that may not be associated with a paging message (e.g., may be skipped). In some aspects, the PO adaptation indication may be associated with an increased periodicity associated with the one or more PFs (or POs). The increased periodicity associated with the one or more PFs, in some aspects, may be a first increased periodicity, and the PO adaptation indication may be associated with an increased number of POs associated with each PF of the one or more PFs that may be based on the first increased periodicity. In some aspects, the increased number of POs associated with each PF may result in one of an increased number of POs, a same number of POs, or a reduced number of POs associated with a DRX cycle. For example, referring to FIG. 6, the UE 604 may receive the PO adaptation indication 632.

At 808, the UE may receive a LO adaptation indication associated with the PO adaptation indication. For example, 808 may be performed by application processor(s) 1006, cellular baseband processor(s) 1024, transceiver(s) 1022, antenna(s) 1080, and/or LO modification component 198 of FIG. 10. In some aspects, receiving the PO adaptation indication at 806 and receiving the LO adaptation indication 808 may include receiving the PO adaptation indication and the LO adaptation indication in a same indication. The indication may be a DCI or other signal indicating one or more of a modification to a paging cycle (e.g., a DRX cycle), a modification of the POs (or PFs) within a paging cycle, a PF bundling in one or more of time and/or frequency, or POs that may not be associated with a paging message (e.g., may be skipped). In some aspects, the PO adaptation indication may be associated with an increased periodicity associated with the one or more PFs (or POs). The updated LO configuration, in some aspects, may include adapting a periodicity of LOs associated with the first LO configuration based on the increased periodicity associated with the one or more PFs (or POs). The increased periodicity associated with the one or more PFs, in some aspects, may be a first increased periodicity, and the PO adaptation indication may be associated with an increased number of POs associated with each PF of the one or more PFs that may be based on the first increased periodicity. In some aspects, the increased number of POs associated with each PF may result in one of an increased number of POs, a same number of POs, or a reduced number of POs associated with a DRX cycle. For example, referring to FIG. 6, the UE 604 may receive the LO adaptation indication 634.

At 810, the UE may update, based on the PO adaptation indication, the first PO configuration to generate the updated PO configuration based on the PO adaptation indication. For example, 810 may be performed by application processor(s) 1006, cellular baseband processor(s) 1024, transceiver(s) 1022, antenna(s) 1080, and/or LO modification component 198 of FIG. 10. For example, referring to FIG. 6, the UE 604 may update the PO configuration at 640.

At 812, the UE may update, based on the LO adaptation indication, the first LO configuration based on the LO adaptation indication to generate the updated LO configuration associated with the updated first configuration of POs. For example, 812 may be performed by application processor(s) 1006, cellular baseband processor(s) 1024, transceiver(s) 1022, antenna(s) 1080, and/or LO modification component 198 of FIG. 10. The updated LO configuration, in some aspects, may include one LO associated with a set of bundled PFs. In some aspects, the updated LO configuration may include multiple LOs associated with a set of bundled PFs, where each LO of the multiple LOs may be associated with a corresponding subset of the set of bundled PFs in a plurality of subsets of bundled PFs. The adjacent subsets of the plurality of subsets of bundled PFs, in some aspects, may be separated by a threshold time. In some aspects, the updated LO configuration may include at least one LO during each paging DRX cycle. For example, referring to FIG. 6, the UE 604 may update the LO configuration at 640.

At 814, the UE may monitor, based on the received PO adaptation indication, LOs according to an updated LO configuration associated with the updated first configuration of POs. For example, 814 may be performed by application processor(s) 1006, cellular baseband processor(s) 1024, transceiver(s) 1022, antenna(s) 1080, and/or LO modification component 198 of FIG. 10. In some aspects, monitoring the LOs may be associated with a low-power radio (e.g., a LP-WUR) of the UE. For example, referring to FIG. 6, the UE 604 may monitor LOs based on the updated LO configuration at 660.

At 816, the UE may output an indication of the configuration of the updated LO configuration. Outputting the indication of the configuration of the updated LO configuration at 816, in some aspects, may include one of transmitting the indication of the configuration of the updated LO configuration at 818, or storing the indication of the configuration of the updated LO configuration at 820. For example, 816, 818, and 820 may be performed by application processor(s) 1006, cellular baseband processor(s) 1024, transceiver(s) 1022, antenna(s) 1080, and/or LO modification component 198 of FIG. 10. For example, referring to FIG. 6, the UE 604 may, at 650, output an indication of the updated PO configuration and/or the updated LO configuration (or an indication that the UE has completed the update of the PO configuration and/or the LO configuration). Outputting the updated PO configuration and/or the LO configuration, in some aspects, may include storing the updated PO configuration and/or the updated LO configuration locally at 654 to use as a basis for monitoring POs and/or LOs at 660. In some aspects, the UE 604 may transmit, and the base station 602 may receive, an updated PO/LO indication 656 that may include an indication of the updated PO configuration and/or the updated LO configuration (or an indication that the UE has completed the update of the PO configuration and/or the LO configuration).

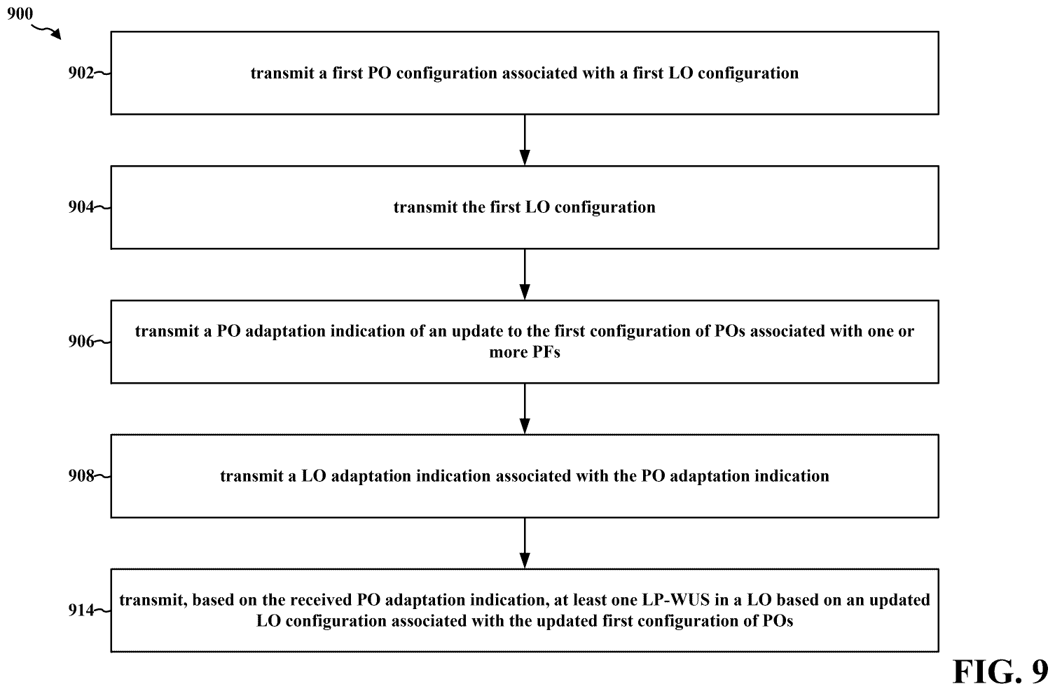

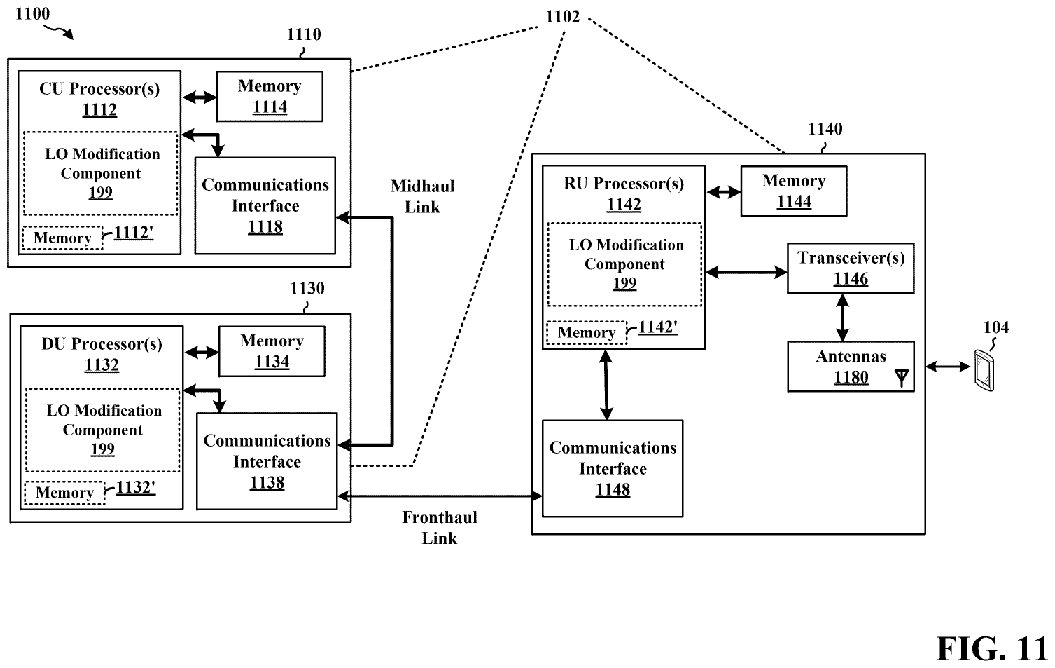

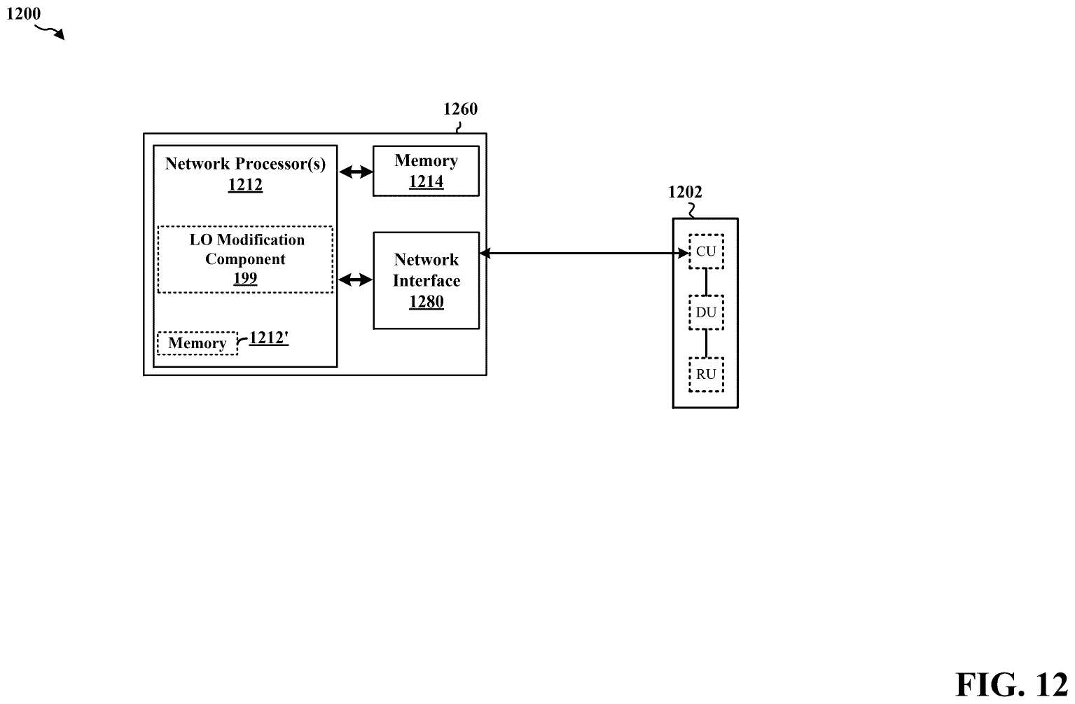

FIG. 9 is a flowchart 900 of a method of wireless communication. The method may be performed by a base station (e.g., the base station 102, 602; the network entity 1002, 1102, 1260). At 902, the base station may transmit a first PO configuration associated with a first LO configuration. For example, 902 may be performed by CU processor(s) 1112, DU processor(s) 1132, RU processor(s) 1142, transceiver(s) 1146, antenna(s) 1180, network processor 1212, network interface 1280, and/or LO modification component 199 of FIGS. 11 and 12. For example, referring to FIG. 6, the base station 602 may transmit the PO configuration 612.

At 904, base station, in some aspects, may transmit the first LO configuration. For example, 904 may be performed by CU processor(s) 1112, DU processor(s) 1132, RU processor(s) 1142, transceiver(s) 1146, antenna(s) 1180, network processor 1212, network interface 1280, and/or LO modification component 199 of FIGS. 11 and 12. In some aspects, transmitting the first LO configuration may include transmitting a mapping from the PO configuration to the first LO configuration. For example, referring to FIG. 6, the base station 602 may transmit the LO configuration 614.

At 906, the base station may transmit a PO adaptation indication of an update to the first configuration of POs associated with one or more PFs. For example, 906 may be performed by CU processor(s) 1112, DU processor(s) 1132, RU processor(s) 1142, transceiver(s) 1146, antenna(s) 1180, network processor 1212, network interface 1280, and/or LO modification component 199 of FIGS. 11 and 12. In some aspects, the updated first configuration of POs may be associated with PF bundling. The PF bundling may be associated with at least one of a time domain or a frequency domain. In some aspects, the PO adaptation indication may be associated with a NES mode of operation. The indication may be a DCI or other signal indicating one or more of a modification to a paging cycle (e.g., a DRX cycle), a modification of the POs (or PFs) within a paging cycle, a PF bundling in one or more of time and/or frequency, or POs that may not be associated with a paging message (e.g., may be skipped). In some aspects, the PO adaptation indication may be associated with an increased periodicity associated with the one or more PFs (or POs). The increased periodicity associated with the one or more PFs, in some aspects, may be a first increased periodicity, and the PO adaptation indication may be associated with an increased number of POs associated with each PF of the one or more PFs that may be based on the first increased periodicity. In some aspects, the increased number of POs associated with each PF may result in one of an increased number of POs, a same number of POs, or a reduced number of POs associated with a DRX cycle. For example, referring to FIG. 6, the base station 602 may transmit the PO adaptation indication 632.

At 908, the base station may transmit a LO adaptation indication associated with the PO adaptation indication. For example, 908 may be performed by CU processor(s) 1112, DU processor(s) 1132, RU processor(s) 1142, transceiver(s) 1146, antenna(s) 1180, network processor 1212, network interface 1280, and/or LO modification component 199 of FIGS. 11 and 12. In some aspects, transmitting the PO adaptation indication at 906 and transmitting the LO adaptation indication 908 may include transmitting the PO adaptation indication and the LO adaptation indication in a same indication. The indication may be a DCI or other signal indicating one or more of a modification to a paging cycle (e.g., a DRX cycle), a modification of the POs (or PFs) within a paging cycle, a PF bundling in one or more of time and/or frequency, or POs that may not be associated with a paging message (e.g., may be skipped). In some aspects, the PO adaptation indication may be associated with an increased periodicity associated with the one or more PFs (or POs). The updated LO configuration, in some aspects, may include adapting a periodicity of LOs associated with the first LO configuration based on the increased periodicity associated with the one or more PFs (or POs). The increased periodicity associated with the one or more PFs, in some aspects, may be a first increased periodicity, and the PO adaptation indication may be associated with an increased number of POs associated with each PF of the one or more PFs that may be based on the first increased periodicity. In some aspects, the increased number of POs associated with each PF may result in one of an increased number of POs, a same number of POs, or a reduced number of POs associated with a DRX cycle. For example, referring to FIG. 6, the base station 602 may transmit the LO adaptation indication 634.

In some aspects, the UE may update, based on the PO adaptation indication, the first PO configuration to generate the updated PO configuration based on the PO adaptation indication. For example, referring to FIG. 6, the UE 604 may update the PO configuration at 640. The UE may update, based on the LO adaptation indication, the first LO configuration based on the LO adaptation indication to generate the updated LO configuration associated with the updated first configuration of POs. The updated LO configuration, in some aspects, may include one LO associated with a set of bundled PFs. In some aspects, the updated LO configuration may include multiple LOs associated with a set of bundled PFs, where each LO of the multiple LOs may be associated with a corresponding subset of the set of bundled PFs in a plurality of subsets of bundled PFs. The adjacent subsets of the plurality of subsets of bundled PFs, in some aspects, may be separated by a threshold time. In some aspects, the updated LO configuration may include at least one LO during each paging DRX cycle. For example, referring to FIG. 6, the UE 604 may update the LO configuration at 640.

At 914, the base station may transmit, based on the received PO adaptation indication, at least one LP-WUS based on an updated LO configuration associated with the updated first configuration of POs. For example, 914 may be performed by CU processor(s) 1112, DU processor(s) 1132, RU processor(s) 1142, transceiver(s) 1146, antenna(s) 1180, network processor 1212, network interface 1280, and/or LO modification component 199 of FIGS. 11 and 12. In some aspects, monitoring for the at least one LP-WUS based on the updated LO configuration may be associated with a low-power radio (e.g., a LP-WUR) of the UE. For example, referring to FIG. 6, the base station 602 may transmit LP-WUS 662 based on the updated LO configuration at 660.

FIG. 10 is a diagram 1000 illustrating an example of a hardware implementation for an apparatus 1004. The apparatus 1004 may be a UE, a component of a UE, or may implement UE functionality. In some aspects, the apparatus 1004 may include at least one cellular baseband processor 1024 (also referred to as a modem) coupled to one or more transceivers 1022 (e.g., cellular RF transceiver). The cellular baseband processor(s) 1024 may include at least one on-chip memory 1024′. In some aspects, the apparatus 1004 may further include one or more subscriber identity modules (SIM) cards 1020 and at least one application processor 1006 coupled to a secure digital (SD) card 1008 and a screen 1010. The application processor(s) 1006 may include on-chip memory 1006′. In some aspects, the apparatus 1004 may further include a Bluetooth module 1012, a WLAN module 1014, an SPS module 1016 (e.g., GNSS module), one or more sensor modules 1018 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1026, a power supply 1030, and/or a camera 1032. The Bluetooth module 1012, the WLAN module 1014, and the SPS module 1016 may include an on-chip transceiver (TRX) (or in some cases, just a receiver (RX)). The Bluetooth module 1012, the WLAN module 1014, and the SPS module 1016 may include their own dedicated antennas and/or utilize one or more antennas 1080 for communication. The cellular baseband processor(s) 1024 communicates through the transceiver(s) 1022 via the one or more antennas 1080 with the UE 104 and/or with an RU associated with a network entity 1002. The cellular baseband processor(s) 1024 and the application processor(s) 1006 may each include a computer-readable medium/memory 1024′, 1006′, respectively. The additional memory modules 1026 may also be considered a computer-readable medium/memory. Each computer-readable medium/memory 1024′, 1006′, 1026 may be non-transitory. The cellular baseband processor(s) 1024 and the application processor(s) 1006 are each responsible for general processing, including the execution of software stored on the computer-readable medium/memory. The software, when executed by the cellular baseband processor(s) 1024/application processor(s) 1006, causes the cellular baseband processor(s) 1024/application processor(s) 1006 to perform the various functions described supra. The computer-readable medium/memory may also be used for storing data that is manipulated by the cellular baseband processor(s) 1024/application processor(s) 1006 when executing software. The cellular baseband processor(s) 1024/application processor(s) 1006 may be a component of the UE 350 and may include the at least one memory 360 and/or at least one of the TX processor 368, the RX processor 356, and the controller/processor 359. In one configuration, the apparatus 1004 may be at least one processor chip (modem and/or application) and include just the cellular baseband processor(s) 1024 and/or the application processor(s) 1006, and in another configuration, the apparatus 1004 may be the entire UE (e.g., see UE 350 of FIG. 3) and include the additional modules of the apparatus 1004.

As discussed supra, the LO modification component 198 may be configured to receive a first PO configuration associated with a first LO configuration, receive a PO adaptation indication of an update to the first configuration of POs associated with one or more PFs, and monitor, based on the received PO adaptation indication, LOs according to an updated LO configuration associated with the updated first configuration of POs. The LO modification component 198 may be within the cellular baseband processor(s) 1024, the application processor(s) 1006, or both the cellular baseband processor(s) 1024 and the application processor(s) 1006. The LO modification component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1004 may include a variety of components configured for various functions. In one configuration, the apparatus 1004, and in particular the cellular baseband processor(s) 1024 and/or the application processor(s) 1006, may include means for receiving a first PO configuration associated with a first LO configuration. The apparatus 1004, and in particular the cellular baseband processor(s) 1024 and/or the application processor(s) 1006, may include means for receiving a PO adaptation indication of an update to the first configuration of POs associated with one or more PFs. The apparatus 1004, and in particular the cellular baseband processor(s) 1024 and/or the application processor(s) 1006, may include means for monitoring, based on the received PO adaptation indication, LOs according to an updated LO configuration associated with the updated first configuration of POs. The apparatus 1004, and in particular the cellular baseband processor(s) 1024 and/or the application processor(s) 1006, may include means for receiving the first LO configuration. The apparatus 1004, and in particular the cellular baseband processor(s) 1024 and/or the application processor(s) 1006, may include means for receiving a LO adaptation indication associated with the PO adaptation indication.

The apparatus 1004, and in particular the cellular baseband processor(s) 1024 and/or the application processor(s) 1006, may include means for updating, based on the PO adaptation indication, the first PO configuration to generate the updated PO configuration based on the PO adaptation indication. The apparatus 1004, and in particular the cellular baseband processor(s) 1024 and/or the application processor(s) 1006, may include means for updating, based on the LO adaptation indication, the first LO configuration based on the LO adaptation indication to generate the updated LO configuration associated with the updated first configuration of POs. The apparatus 1004, and in particular the cellular baseband processor(s) 1024 and/or the application processor(s) 1006, may include means for receiving the PO adaptation indication and the LO adaptation indication in a same indication. The apparatus 1004, and in particular the cellular baseband processor(s) 1024 and/or the application processor(s) 1006, may include means for outputting an indication of the configuration of the updated LO configuration. The apparatus 1004, and in particular the cellular baseband processor(s) 1024 and/or the application processor(s) 1006, may include means for transmitting the indication of the configuration of the updated LO configuration. The apparatus 1004, and in particular the cellular baseband processor(s) 1024 and/or the application processor(s) 1006, may include means for storing the indication of the configuration of the updated LO configuration. The apparatus 1004 may further include means for performing any of the aspects described in connection with the flowcharts in FIG. 7 or 8, and/or performed by the UE in the communication flow of FIG. 6. The means may be the LO modification component 198 of the apparatus 1004 configured to perform the functions recited by the means. As described supra, the apparatus 1004 may include the TX processor 368, the RX processor 356, and the controller/processor 359. As such, in one configuration, the means may be the TX processor 368, the RX processor 356, and/or the controller/processor 359 configured to perform the functions recited by the means.

FIG. 11 is a diagram 1100 illustrating an example of a hardware implementation for a network entity 1102. The network entity 1102 may be a BS, a component of a BS, or may implement BS functionality. The network entity 1102 may include at least one of a CU 1110, a DU 1130, or an RU 1140. For example, depending on the layer functionality handled by the LO modification component 199, the network entity 1102 may include the CU 1110; both the CU 1110 and the DU 1130; each of the CU 1110, the DU 1130, and the RU 1140; the DU 1130; both the DU 1130 and the RU 1140; or the RU 1140. The CU 1110 may include at least one CU processor 1112. The CU processor(s) 1112 may include on-chip memory 1112′. In some aspects, the CU 1110 may further include additional memory modules 1114 and a communications interface 1118. The CU 1110 communicates with the DU 1130 through a midhaul link, such as an F1 interface. The DU 1130 may include at least one DU processor 1132. The DU processor(s) 1132 may include on-chip memory 1132′. In some aspects, the DU 1130 may further include additional memory modules 1134 and a communications interface 1138. The DU 1130 communicates with the RU 1140 through a fronthaul link. The RU 1140 may include at least one RU processor 1142. The RU processor(s) 1142 may include on-chip memory 1142′. In some aspects, the RU 1140 may further include additional memory modules 1144, one or more transceivers 1146, one or more antennas 1180, and a communications interface 1148. The RU 1140 communicates with the UE 104. The on-chip memory 1112′, 1132′, 1142′ and the additional memory modules 1114, 1134, 1144 may each be considered a computer-readable medium/memory. Each computer-readable medium/memory may be non-transitory. Each of the processors 1112, 1132, 1142 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the LO modification component 199 may be configured to transmit a first PO configuration associated with a first LO configuration, transmit a PO adaptation indication of an update to the first configuration of POs associated with one or more PFs, and transmit, based on the received PO adaptation indication, at least one LP-WUS based on an updated LO configuration associated with the updated first configuration of POs. The LO modification component 199 may be within one or more processors of one or more of the CU 1110, DU 1130, and the RU 1140. The LO modification component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1102 may include a variety of components configured for various functions. In one configuration, the network entity 1102 may include means for transmitting a first PO configuration associated with a first LO configuration. The network entity 1102, in some aspects, may include means for transmitting a PO adaptation indication of an update to the first configuration of POs associated with one or more PFs. The network entity 1102, in some aspects, may include means for transmitting, based on the received PO adaptation indication, at least one LP-WUS based on an updated LO configuration associated with the updated first configuration of POs. The network entity 1102, in some aspects, may include means for transmitting a first LO configuration. The network entity 1102, in some aspects, may include means for transmitting a LO adaptation indication of an update to the configuration of LOs associated with the PO adaptation indication. The network entity 1102 may further include means for performing any of the aspects described in connection with the flowchart in FIG. 9, and/or performed by the base station in the communication flow of FIG. 6. The means may be the LO modification component 199 of the network entity 1102 configured to perform the functions recited by the means. As described supra, the network entity 1102 may include the TX processor 316, the RX processor 370, and the controller/processor 375. As such, in one configuration, the means may be the TX processor 316, the RX processor 370, and/or the controller/processor 375 configured to perform the functions recited by the means.

FIG. 12 is a diagram 1200 illustrating an example of a hardware implementation for a network entity 1260. In one example, the network entity 1260 may be within the core network 120. The network entity 1260 may include at least one network processor 1212. The network processor(s) 1212 may include on-chip memory 1212′. In some aspects, the network entity 1260 may further include additional memory modules 1214. The network entity 1260 communicates via the network interface 1280 directly (e.g., backhaul link) or indirectly (e.g., through a RIC) with the CU 1202. The on-chip memory 1212′ and the additional memory modules 1214 may each be considered a computer-readable medium/memory. Each computer-readable medium/memory may be non-transitory. The network processor(s) 1212 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the LO modification component 199 may be configured to transmit a first PO configuration associated with a first LO configuration, transmit a PO adaptation indication of an update to the first configuration of POs associated with one or more PFs, and transmit, based on the received PO adaptation indication, at least one LP-WUS based on an updated LO configuration associated with the updated first configuration of POs. The LO modification component 199 may be within the network processor(s) 1212. The LO modification component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1260 may include a variety of components configured for various functions. In one configuration, the network entity 1260 may include means for transmitting a first PO configuration associated with a first LO configuration. The network entity 1260, in some aspects, may include means for transmitting a PO adaptation indication of an update to the first configuration of POs associated with one or more PFs. The network entity 1260, in some aspects, may include means for transmitting, based on the received PO adaptation indication, at least one LP-WUS based on an updated LO configuration associated with the updated first configuration of POs. The network entity 1260, in some aspects, may include means for transmitting a first LO configuration. The network entity 1260, in some aspects, may include means for transmitting a LO adaptation indication of an update to the configuration of LOs associated with the PO adaptation indication. The network entity 1260 may further include means for performing any of the aspects described in connection with the flowchart in FIG. 9, and/or performed by the base station in the communication flow of FIG. 6. The means may be the LO modification component 199 of the network entity 1260 configured to perform the functions recited by the means.

Various aspects relate generally to adapting the LOs based on an adaptation of POs. Some aspects more specifically relate to providing and/or specifying how to identify a modified pattern of the LOs in association with a new configuration for adapted POs (e.g., NES POs, clustered POs, extended POs) so that UE does not wake-up unnecessarily. In some examples, a wireless device may be configured to receive a first PO configuration associated with a first LO configuration, receive a PO adaptation indication of an update to the first configuration of POs associated with one or more PFs, and monitor, based on the received PO adaptation indication, LOs according to an updated LO configuration associated with the updated first configuration of POs. In some examples, a network device may be configured to transmit a first PO configuration associated with a first LO configuration, transmit a PO adaptation indication of an update to the first configuration of POs associated with one or more PFs, and transmit, based on the received PO adaptation indication, at least one LP-WUS based on an updated LO configuration associated with the updated first configuration of POs.

Particular aspects of the subject matter described in this disclosure can be implemented to realize one or more of the following potential advantages. In some examples, by modifying the LO configuration based on a modified set of POs, the described techniques can be used to reduce the energy associated with monitoring for LOs and avoid monitoring for/of LOs that are not associated with POs.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a user equipment (UE) comprising: receiving a first paging occasion (PO) configuration associated with a first low power wake up sequence (LP-WUS) occasion (LO) configuration; receiving a PO adaptation indication of an update to the first configuration of POs associated with one or more paging frames (PFs); and monitoring, based on the received PO adaptation indication, LOs according to an updated LO configuration associated with the updated first configuration of POs.

Aspect 2 is the method of aspect 1, wherein the updated first configuration of POs is associated with PF bundling.

Aspect 3 is the method of aspect 2, wherein the PF bundling is associated with at least one of a time domain or a frequency domain.

Aspect 4 is the method of any of aspects 2 and 3, wherein the updated LO configuration includes one LO associated with a set of bundled PFs.

Aspect 5 is the method of any of aspects 2 and 3, wherein the updated LO configuration includes multiple LOs associated with a set of bundled PFs, wherein each LO of the multiple LOs is associated with a corresponding subset of the set of bundled PFs in a plurality of subsets of bundled PFs.

Aspect 6 is the method of aspect 5, wherein adjacent subsets of the plurality of subsets of bundled PFs are separated by a threshold time.

Aspect 7 is the method of any of aspects 1 to 6, further comprising: receiving the first LO configuration; receiving a LO adaptation indication associated with the PO adaptation indication; updating, based on the PO adaptation indication, the first PO configuration to generate the updated PO configuration based on the PO adaptation indication; and updating, based on the LO adaptation indication, the first LO configuration based on the LO adaptation indication to generate the updated LO configuration associated with the updated first configuration of POs.

Aspect 8 is the method of aspect 7, wherein receiving the PO adaptation indication and receiving the LO adaptation indication comprises receiving the PO adaptation indication and the LO adaptation indication in a same indication.

Aspect 9 is the method of any of aspects 1 to 8, wherein the PO adaptation indication is associated with an increased periodicity associated with the one or more PFs.

Aspect 10 is the method of aspect 9, wherein the updated LO configuration comprises an updated periodicity of LOs associated with the first LO configuration based on the increased periodicity associated with the one or more PFs.

Aspect 11 is the method of any of aspects 9 and 10, wherein the increased periodicity associated with the one or more PFs is a first increased periodicity, and wherein the PO adaptation indication is associated with an increased number of POs associated with each PF of the one or more PFs that is based on the first increased periodicity.

Aspect 12 is the method of any of aspects 1 to 11, wherein the updated LO configuration includes at least one LO during each paging discontinuous reception (DRX) cycle.

Aspect 13 is the method of any of aspects 1 to 12, wherein the monitoring the LOs is associated with a low-power radio of the UE.

Aspect 14 is the method of any of aspects 1 to 13, wherein the PO adaptation indication is associated with a network energy saving (NES) mode of operation.

Aspect 15 is the method of any of aspects 1 to 14, further comprising: outputting an indication of the configuration of the updated LO configuration.

Aspect 16 is the method of aspect 15, wherein outputting the indication of the configuration of the LO configuration comprises: transmitting the indication of the configuration of the updated LO configuration; or storing the indication of the configuration of the updated LO configuration.

Aspect 17 is a method of wireless communication at a network device comprising: transmitting a first paging occasion (PO) configuration associated with a first low power wake up sequence (LP-WUS) occasion (LO) configuration; transmitting a PO adaptation indication of an update to the first configuration of POs associated with one or more paging frames (PFs); and transmitting, based on the received PO adaptation indication, at least one LP-WUS based on an updated LO configuration associated with the updated first configuration of POs.

Aspect 18 is the method of aspect 17, wherein the updated first configuration of POs is associated with PF bundling.

Aspect 19 is the method of aspect 18, wherein the PF bundling is associated with at least one of a time domain or a frequency domain.

Aspect 20 is the method of any of aspects 18 and 19, wherein the updated LO configuration includes one LO associated with a set of bundled PFs.

Aspect 21 is the method of any of aspects 18 and 19, wherein the updated LO configuration includes multiple LOs associated with a set of bundled PFs, wherein each LO of the multiple LOs is associated with a corresponding subset of the set of bundled PFs in a plurality of subsets of bundled PFs.

Aspect 22 is the method of aspect 21, wherein adjacent subsets of the plurality of subsets of bundled PFs are separated by a threshold time.

Aspect 23 is the method of any of aspects 17 to 22, further comprising: transmitting the first LO configuration; and transmitting a LO adaptation indication associated with the PO adaptation indication.

Aspect 24 is the method of aspect 23, wherein transmitting the PO adaptation indication and transmitting the LO adaptation indication comprises transmitting the PO adaptation indication and the LO adaptation indication in a same indication.

Aspect 25 is the method of any of aspects 17 to 24, wherein the PO adaptation indication is associated with an increased periodicity associated with the one or more PFs.

Aspect 26 is the method of aspect 25, wherein the updated LO configuration comprises an updated a periodicity of LOs associated with the first LO configuration based on the increased periodicity associated with the one or more PFs.

Aspect 27 is the method of any of aspects 25 and 26, wherein the increased periodicity associated with the one or more PFs is a first increased periodicity, and wherein the PO adaptation indication is associated with an increased number of POs associated with each PF of the one or more PFs that is based on the first increased periodicity.

Aspect 28 is the method of any of aspects 17 to 27, wherein the updated LO configuration includes at least one LO during each paging discontinuous reception (DRX) cycle.

Aspect 29 is an apparatus for wireless communication at a device including a memory and at least one processor coupled to the memory and, based at least in part on information stored in the memory, the at least one processor is configured to implement any of aspects 1 to 16.

Aspect 30 is the apparatus of aspect 29, further including a transceiver or an antenna coupled to the at least one processor.

Aspect 31 is an apparatus for wireless communication at a device including means for implementing any of aspects 1 to 16.

Aspect 32 is a computer-readable medium (e.g., a non-transitory computer-readable medium) storing computer executable code, where the code when executed by a processor causes the processor to implement any of aspects 1 to 16.

Aspect 33 is an apparatus for wireless communication at a device including a memory and at least one processor coupled to the memory and, based at least in part on information stored in the memory, the at least one processor is configured to implement any of aspects 17 to 28.

Aspect 34 is the apparatus of aspect 33, further including a transceiver or an antenna coupled to the at least one processor.

Aspect 35 is an apparatus for wireless communication at a device including means for implementing any of aspects 17 to 28.

Aspect 36 is a computer-readable medium (e.g., a non-transitory computer-readable medium) storing computer executable code, where the code when executed by a processor causes the processor to implement any of aspects 17 to 28.

What is claimed is:

1. An apparatus for wireless communication at a user equipment (UE), comprising:
at least one memory; and
at least one processor coupled to the at least one memory and, based at least in part on stored information that is stored in the at least one memory, the at least one processor, individually or in any combination, is configured to:
receive a first paging occasion (PO) configuration associated with a first low power wake up sequence (LP-WUS) occasion (LO) configuration;
receive a PO adaptation indication of an update to the first configuration of POs associated with one or more paging frames (PFs); and
monitor, based on the received PO adaptation indication, LOs according to an updated LO configuration associated with the updated first configuration of POs.

2. The apparatus of claim 1, wherein the updated first configuration of POs is associated with PF bundling.

3. The apparatus of claim 2, wherein the PF bundling is associated with at least one of a time domain or a frequency domain.

4. The apparatus of claim 2, wherein the updated LO configuration includes one LO associated with a set of bundled PFs.

5. The apparatus of claim 2, wherein the updated LO configuration includes multiple LOs associated with a set of bundled PFs, wherein each LO of the multiple LOs is associated with a corresponding subset of the set of bundled PFs in a plurality of subsets of bundled PFs.

6. The apparatus of claim 5, wherein adjacent subsets of the plurality of subsets of bundled PFs are separated by a threshold time.

7. The apparatus of claim 1, further comprising a transceiver coupled to the at least one processor, wherein the at least one processor, individually or in any combination, is further configured to:
receive, via the transceiver, the first LO configuration;
receive a LO adaptation indication associated with the PO adaptation indication;
update, based on the PO adaptation indication, the first PO configuration to generate the updated PO configuration based on the PO adaptation indication; and
update, based on the LO adaptation indication, the first LO configuration based on the LO adaptation indication to generate the updated LO configuration associated with the updated first configuration of POs.

8. The apparatus of claim 7, wherein, to receive the PO adaptation indication and to receive the LO adaptation, the at least one processor, individually or in any combination, is configured to receive the PO adaptation indication and the LO adaptation indication in a same indication.

9. The apparatus of claim 1, wherein the PO adaptation indication is associated with an increased periodicity associated with the one or more PFs.

10. The apparatus of claim 9, wherein the updated LO configuration comprises an updated periodicity of LOs associated with the first LO configuration based on the increased periodicity associated with the one or more PFs.

11. The apparatus of claim 9, wherein the increased periodicity associated with the one or more PFs is a first increased periodicity, and wherein the PO adaptation indication is associated with an increased number of POs associated with each PF of the one or more PFs that is based on the first increased periodicity.

12. The apparatus of claim 1, wherein the updated LO configuration includes at least one LO during each paging discontinuous reception (DRX) cycle.

13. The apparatus of claim 1, wherein the apparatus further comprises a low-power radio, and wherein to monitor the LOs, the at least one processor, individually or in any combination, is configured to use the low-power radio to monitor the LOs.

14. The apparatus of claim 1, wherein the PO adaptation indication is associated with a network energy saving (NES) mode of operation.

15. The apparatus of claim 1, wherein the at least one processor, individually or in any combination, is further configured to:
output an indication of the configuration of the updated LO configuration.

16. The apparatus of claim 15, wherein, to output the indication of the configuration of the LO configuration, the at least one processor, individually or in any combination, is configured to:
transmit the indication of the configuration of the updated LO configuration; or
store the indication of the configuration of the updated LO configuration.

17. A method of wireless communication at a user equipment (UE) comprising:
receiving a first paging occasion (PO) configuration associated with a first low power wake up sequence (LP-WUS) occasion (LO) configuration;
receiving a PO adaptation indication of an update to the first configuration of POs associated with one or more paging frames (PFs); and
monitoring, based on the received PO adaptation indication, LOs according to an updated LO configuration associated with the updated first configuration of POs.

18. The method of claim 17, further comprising:
receiving the first LO configuration;
receiving a LO adaptation indication associated with the PO adaptation indication;
updating, based on the PO adaptation indication, the first PO configuration to generate the updated PO configuration based on the PO adaptation indication; and
updating, based on the LO adaptation indication, the first LO configuration based on the LO adaptation indication to generate the updated LO configuration associated with the updated first configuration of POs.

19. The method of claim 18, wherein receiving the PO adaptation indication and receiving the LO adaptation comprises receiving the PO adaptation indication and the LO adaptation indication in a same indication.

20. A computer-readable medium storing computer executable code at a user equipment (UE), the code when executed by a processor causes the processor to:
receive a first paging occasion (PO) configuration associated with a first low power wake up sequence (LP-WUS) occasion (LO) configuration;
receive a PO adaptation indication of an update to the first configuration of POs associated with one or more paging frames (PFs); and
monitor, based on the received PO adaptation indication, LOs according to an updated LO configuration associated with the updated first configuration of POs.
